(19) United States
(12) Patent Application Publication
(10) Pub. No.: US 2026/0050089 A1
(43) Pub. Date: Feb. 19, 2026

(54) MULTI-STAGE SIGNAL ACQUISITION

(71) Applicant: BAE SYSTEMS Information and Electronic Systems Integration Inc., Nashua, NH (US)

(72) Inventors: Michael N. Kloos, Atkins, IA (US); Mitchell Dennis, Cedar Rapids, IA (US)

(73) Assignee: BAE SYSTEMS Information and Electronic Systems Integration Inc., Nashua, NH (US)

(21) Appl. No.: 18/742,663

(22) Filed: Jun. 13, 2024

(51) Int. Cl. G01S 19/24; G01S 19/31; H04B 17/309

(52) U.S. Cl. CPC G01S 19/24; G01S 19/31; H04B 17/346

(57) ABSTRACT

A signal acquisition device includes a first stage processing module configured to correlate a first set of radio frequency (RF) signal samples to a plurality of generated tones, identify a candidate RF signal sample among the correlated first set of RF signal samples based on a peak magnitude of the correlated first set of RF signal samples, the candidate RF signal sample having a first correlation magnitude exceeding a first threshold value, and output an interpolated tone based on the candidate RF signal sample; and a second stage processing module configured to correlate a second set of RF signal samples corresponding to the interpolated tone to a plurality of code signals, and to output an output tone having a second correlation magnitude exceeding a second threshold value.

### STATEMENT OF GOVERNMENT INTEREST

This invention was made with government support under prime contract number FA8807 19 C 0003 awarded by the U. S. Air Force Space & Missile Systems Center. The government has certain rights in the invention.

### FIELD OF DISCLOSURE

The present disclosure relates to signal processing techniques, and more particularly, to techniques for multi-stage, multi-burst signal acquisition.

### BACKGROUND

Satellite-based radio navigation systems include a constellation of satellites in Earth orbit that transmit signals to a receiver on Earth. The receiver first acquires the signals from multiple satellites (typically three or more) in different orbital positions, and then computes its geographical position based on information obtained from the signals. Due to propagation delays, Doppler effects, and noise, there are non-trivial issues relating to the acquisition of these signals.

### BRIEF DESCRIPTION OF THE DRAWINGS

FIG. 1 is a block diagram of a satellite system, in accordance with an example of the present disclosure.

FIG. 2 depicts a constellation of satellites in Earth orbit, in accordance with an example of the present disclosure.

FIG. 3 is a block diagram of a receiver of the satellite system of FIG. 1, in accordance with an example of the present disclosure.

FIG. 4 is a block diagram of a signal acquisition search engine of the receiver of FIG. 3, in accordance with an example of the present disclosure.

FIG. 5 is a more detailed block diagram of the signal acquisition search engine of FIG. 4, in accordance with an example of the present disclosure.

FIG. 6 is a schematic diagram of a first stage processing module of the signal acquisition search engine of FIGS. 4 and 5, in accordance with an example of the present disclosure.

FIG. 7 is a schematic diagram of a second stage processing module of the signal acquisition search engine of FIGS. 4 and 5, in accordance with an example of the present disclosure.

FIG. 8 is a table showing examples of configurable parameters for the first stage processing module of FIG. 6, in accordance with an example of the present disclosure.

FIG. 9 is a table showing examples of configurable parameters for the second stage processing module of FIG. 7, in accordance with an example of the present disclosure.

FIG. 10 is a graph showing two signal burst correlations over time, in accordance with an example of the present disclosure.

FIG. 11 is a flow diagram of a frequency pruning process, in accordance with an example of the present disclosure.

FIG. 12 is a flow diagram of an example method for signal acquisition, in accordance with an example of the present disclosure.

FIG. 13 is a block diagram of a processing platform configured to provide a system for multi-stage, multi-burst signal acquisition, in accordance with an example of the present disclosure.

Although the following detailed description refers to illustrative examples, many alternatives, modifications, and variations thereof will be apparent in light of this disclosure.

### DETAILED DESCRIPTION

Techniques are provided herein for efficient multi-stage, multi-burst signal acquisition. In an example, a signal acquisition device includes a first stage processing module configured to correlate a first set of radio frequency (RF) signal samples to a plurality of generated tones, identify a candidate RF signal sample among the correlated first set of RF signal samples based on a peak magnitude of the correlated first set of RF signal samples, and output an interpolated tone based on the candidate RF signal sample. The candidate RF signal sample has a first correlation magnitude exceeding a first threshold value. The signal acquisition device further includes a second stage processing module configured to correlate a second set of the RF signal samples corresponding to the interpolated tone to a plurality of code signals, and to output an output tone having a second correlation magnitude exceeding a second threshold value.

In another example, a signal acquisition device includes a first stage processing module configured to correlate a first set of RF signal samples to a plurality of generated tones, generate a noise energy estimate based on an average correlation magnitude of each of the first set of RF signal samples occurring prior to and during a programmable waiting period, and identify a candidate RF signal sample among the correlated first set of RF signal samples based on a peak magnitude of the correlated first set of RF signal samples. The candidate RF signal sample has a first correlation magnitude exceeding a first threshold value based at least in part on the noise energy estimate. The programmable waiting period begins at a time when the candidate RF signal sample reaches the peak magnitude. The first stage processing module is further configured to output an interpolated tone based on the candidate RF signal sample. The signal acquisition device further includes a second stage processing module configured to correlate a second set of the RF signal samples corresponding to the interpolated tone to a plurality of code signals, and to output an output tone having a second correlation magnitude exceeding a second threshold value.

In yet another example, a signal acquisition device includes a first stage processing module configured to correlate a first set of radio frequency (RF) signal samples to a plurality of generated tones, and output at least one interpolated tone based on the correlated first set of RF signal samples. The signal acquisition device further includes a second stage processing module configured to correlate a second set of the RF signal samples corresponding to the at least one interpolated tone to a plurality of code signals using a window length based on a peak magnitude of the correlated first set of RF signal samples, and to output an output tone having a second correlation magnitude exceeding a second threshold value.

In some examples, the signal acquisition device incorporates one or more techniques to improve the efficiency of the first and second stage processing modules. For example, the first stage processing module is configured to filter out or otherwise ignore samples from the first set of RF signal samples based on the time of arrival of the signal sample, the noise threshold applied to the signal sample, and the frequency of the signal sample. This reduces processing of signal bursts that are not likely to be of interest for acquisition. In another example, the second stage processing module is configurable (e.g., in software) to adapt the size of the search space based on the time of arrival accuracy of the first stage processing module, such as by reducing the window length (number of samples) for a given carrier-to-signal ratio (CN₀) in the signal bursts. In yet another example, the filtering thresholds in the first stage processing module can be adapted (throttled) based on the depth of an intermediate buffer (e.g., a first-in, first-out, or FIFO, buffer) between the first and second stage processing modules.

### Overview

A receiver first acquires signals from multiple satellites and then computes its geographical position (or other information) based on data encoded in the signals. The signals can, for example, include navigational information (e.g., a time code) or other data uniquely encoded for each satellite and then modulated onto a carrier frequency for transmission, typically with further in-phase and quadrature (IQ) encoding to help the receiver decode the data rapidly, accurately, and reliably. At the receiver, the signals are subject to propagation delay and Doppler frequency shift.

The power of the signals transmitted by the satellites is typically low and therefore the signals are susceptible to noise. The noise can originate from the satellite transmitter, the receiver, or both. Additional noise may result from multipath propagation, background sources, and other external effects on the transmission. As noted above, the signals are further subject to a Doppler frequency shift that results from the relative motion of the satellite and the receiver. If the noise level and the Doppler frequency shift are relatively high, the time and frequency uncertainty of the signal at the receiver is inherently high, increasing the difficulty of signal detection, discrimination, and acquisition. Therefore, non-trivial issues remain with respect to signal acquisition.

Although all of the satellites typically transmit the signals in bursts in the same frequency band, the receiver will receive the signals at far different frequencies due to different Doppler shifts of various satellites, and therefore cannot discriminate signals from different satellites based on the frequency of the signals or the presence of energy alone. This can be particularly problematic if the signals from two or more satellites are received contemporaneously, which is also referred to as a multi-burst. Multi-bursts can occur at the receiver when multiple satellites transmit signals arrive during the same time interval or when the signals overlap due to the differing propagation delays, which are different for each satellite. Furthermore, signals from satellites in low Earth orbit (LEO) are more likely to overlap at the receiver than those in medium Earth orbit (MEO) due to the relative proximity of the satellites to the receiver, the closeness in time of the signal bursts, and/or when multiple sources are transmitting in a congested network.

To address these problems, in accordance with an example of the present disclosure, the receiver discriminates among signals (bursts) originating from multiple satellites or other sources based on the propagation delay and the Doppler frequency shift. The receiver acquires each signal by searching for a correlation peak in the detected signal preamble across a search space, which is a known set of correlation values (e.g., discrete Fourier Transform or DFT values with arbitrary spacing between tones) for a given satellite and is based on the propagation delay and the Doppler frequency shift. Correlation peaks that exceed other correlation values are likely to represent the time signal as opposed to noise. Thus, by monitoring the time signal and the Doppler frequency shift over a short time interval, the receiver can acquire the signal for subsequently determining its location relative to the satellite.

When both the noise level and the Doppler frequency shift are relatively high, such as with low power, low orbit satellites, the receiver uses a larger search space to locate the correlation peaks. However, with certain existing signal acquisition techniques, such large search spaces may require a very large brute force search to cover the time and frequency uncertainty. Such a search process is computationally expensive, time consuming, and potentially less precise if certain correlation peaks are not found.

To this end, examples of the present disclosure provide techniques for an efficient multi-stage, multi-burst signal acquisition search, which can be used to correlate and search for signal patterns in two dimensions: time code offset and Doppler frequency shift. In some examples, the signal correlation patterns are specified in software or firmware and processed by a search engine in two stages. The first stage performs Doppler detection across a wide search range to identify candidate signals, and the second stage performs a refined search on the candidate signals. The search engine can process signals that have a tone preamble followed by Binary Phase-shift Keying (BPSK) data modulated tones and to search a large Doppler range with arbitrary tone spacing. The engine can search in real time and continuously searches in time and the full Doppler search range.

In the first stage, the search engine continuously searches sampled input signals (bursts) for candidate correlation peaks that exceed a configurable first stage correlation threshold across a wide Doppler frequency range. The time code offset and the Doppler frequency shift of candidate signals detected at the receiver, along with frequency interpolations between the two strongest tones that estimate the exact tone for the candidate signal (because the tones used for correlation, depending on spacing, may not align with the tone corresponding to the candidate signal), are written into a memory buffer, which is indexed into a raw IQ circular buffer for further processing by the second stage. The sample rate, the Doppler search range and granularity, and the pre-detection integration (PDI) intervals for processing the signal can be independently configured for each stage to minimize loss and false alarm rate, while also preventing or reducing the chance of a missed detection. The candidate correlation peaks are stored in a FIFO buffer.

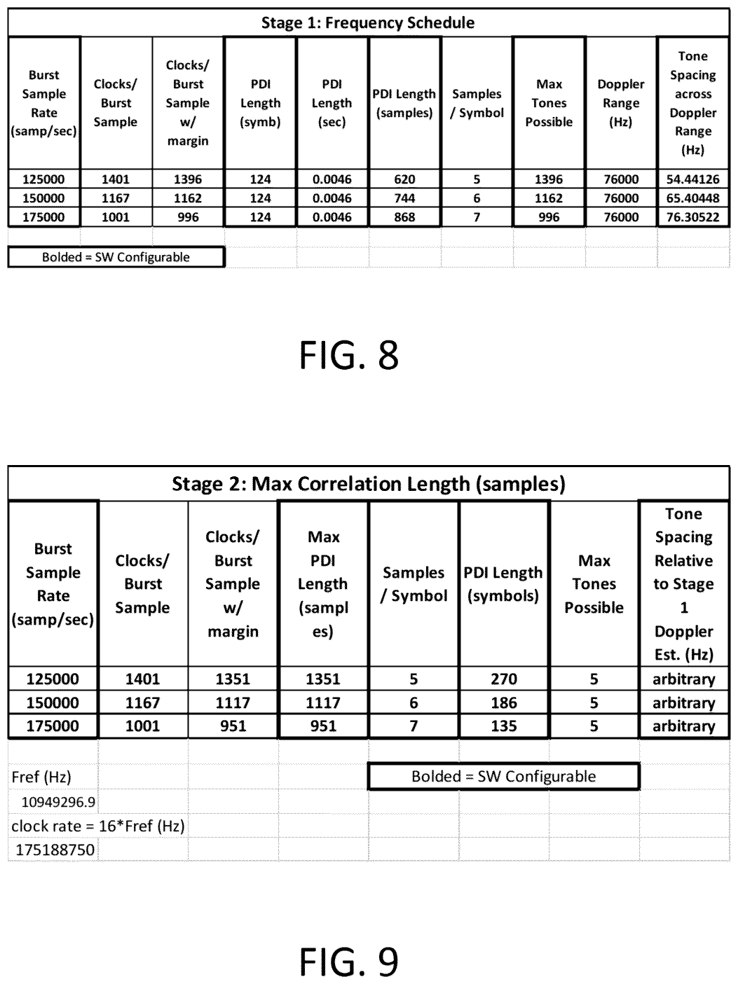

In the second stage, the search engine takes the interpolated center tone associated with the candidate correlation peak from the FIFO and constructs a tone generator at the interpolated center tone frequency and at the frequencies of two tones on either side of the center tone. The spacing between the tones is configurable in software. The search engine computes a magnitude of the corresponding candidate correlation peak (computed via CORDIC) above a configurable second stage correlation threshold, and passes the magnitude of the peak into a sorter. The sorter outputs the maximum magnitude of all the tones, as well as the magnitude of the adjacent tones, or bins. As used herein, the terms “bin” and “frequency bin,” in addition to their plain and ordinary meanings, each refer to the frequency resolution of a set of signal samples. For example, if the sample length is 1 second and the sampling rate is 10 samples per second (for a total of 10 samples), then there are 10 bins each having a width of 1 Hz. In another example, to specify the tone spacing according to how many clocks occur between samples, tones can be placed closer than 1 bin=1/(PDI length). For instance, in FIG. 8, first row, shows a PDI of 0.00496, which leads to a bin width of 201.61 Hz. However, because of the clock rates and sample rates for that row, a tone spacing of 54.44 Hz is used (instead of 201.6 Hz), which improves frequency resolution.

In further detail, in the first stage, the search engine correlates tones by integrating samples of the input signal over a sliding PDI interval window. For each PDI interval, the correlation contribution for the latest (most recent) sample of multiple tone generators is added to a running summation of the correlation contributions over the PDI interval window, and the correlation contribution from the earliest sample in the PDI interval window is subtracted from the running summation. This results in an efficient sliding correlation where the length of the correlation is constant and thus does not change the processing load of the search engine. The number of tones in the first stage is governed by the clock rate of the processor and the incoming sample rate. (PDI in the first stage is not governed by clock rates).

In the second stage, the search engine correlates the candidate tones and a set of code signals to further refine the search results. The number of samples in the second stage correlation is governed by the clock rate of the processor and the incoming sample rate. Independent correlation thresholds for each stage are used to minimize the probability of false positives as well as missed detection. The correlation thresholds are selected as a software-supplied multiplier of the noise energy, or as a programmable absolute value in each stage, to allow for maximum flexibility. A CORDIC algorithm computes magnitudes of correlations across all Doppler tones, for each sample input to the engine.

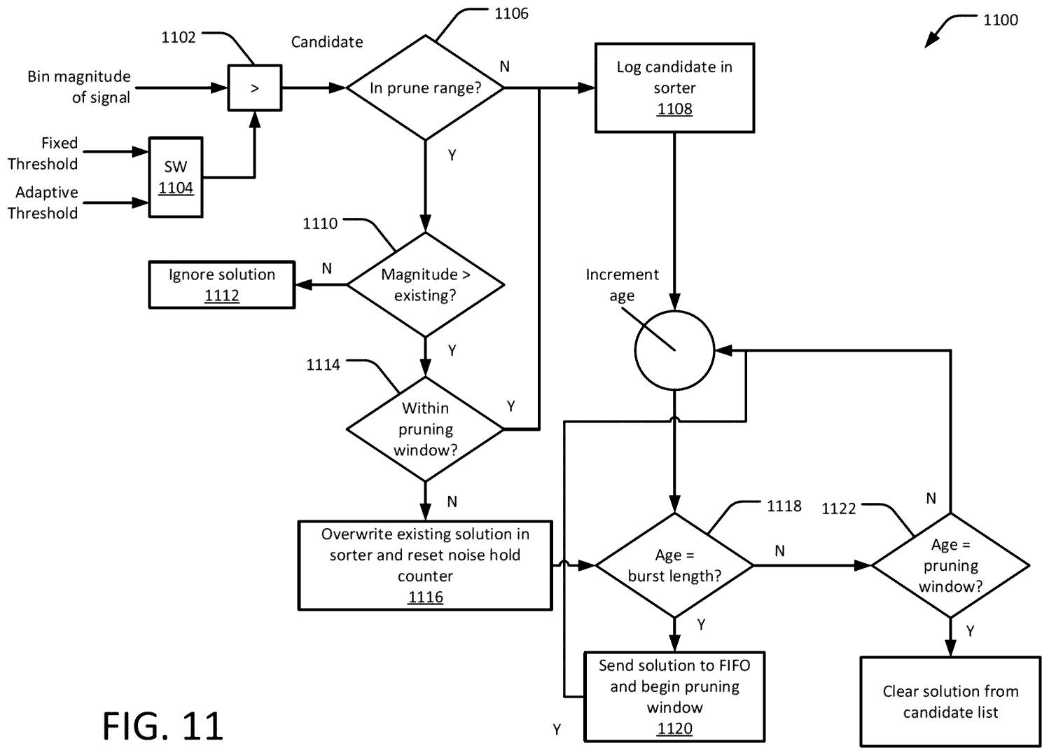

If a potential signal burst exceeds the first stage threshold, the tone (or an interpolated tone) corresponding to the signal is stored in a FIFO. For instance, a frequency interpolation can be performed between the two strongest tones to estimate the exact tone for the burst and this information is stored in the FIFO. As described in further detail with respect to FIG. 11, in some examples the efficiency of the search engine can be improved by filtering out (frequency pruning) any signal bursts that arrive with a frequency pruning window of the candidate signal. Such filtering accounts for noise peaks that occur within the vicinity of the candidate signal, which are unlikely to be signals of interest, and eliminates the need to process such signal bursts. In this manner, fewer interpolated (candidate) tones are provided to the second stage for processing, improving the efficiency of the search engine.

The second stage takes the interpolated tone from the FIFO and constructs a tone generator at that frequency and at two tones on either side of the center tone (the tone spacing is software configurable). The second stage correlates on the code signal onto tones whose separation is set by software. If the second stage detects a magnitude (computed via CORDIC) above the second stage threshold, that value is passed into a sorter. The maximum magnitude on all the tones is then reported to software for further processing, such as for acquisition and tracking. In some examples, the number of interpolated (candidate) tones can be increased or otherwise regulated by improving the efficiency of the first stage and/or by adapting the filters employed in the first stage to ensure that the second stage is not starved of interpolated tones, as discussed herein.

### Example Satellite System

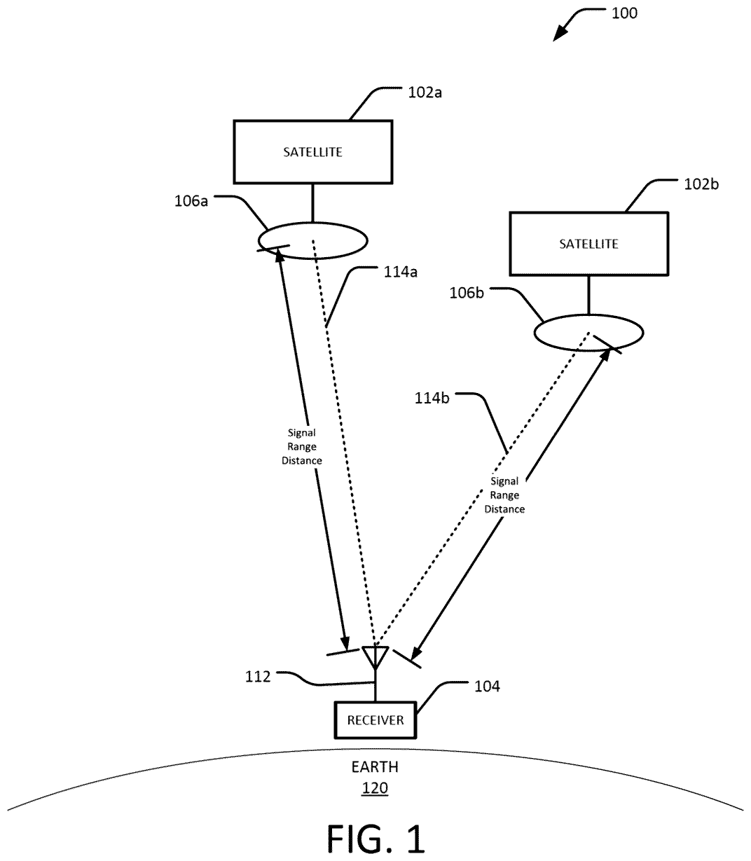

FIG. 1 is a block diagram of a satellite system 100, in accordance with an example of the present disclosure. FIG. 1 is not drawn to scale, and the dimensions represented in the drawing are provided for clarity. The system 100 includes at least one satellite platform 102a and a receiver 104. In some examples, there are multiple satellite platforms 102a, 102b, etc. Each satellite platform 102a, 102b has at least one transmit antenna 106a, 106b. The receiver 104 has a receive antenna 112 for receiving signals transmitted from the transmit antenna 106a, 106b.

The satellite platforms 102a, 102b are in an orbit around the Earth 120, such as a geostationary orbit, a medium earth orbit (MEO), or a low Earth orbit (LEO). The receiver 104 can be located, for example, on land, in air, or at sea. The satellite platforms 102a, 102b are each configured to transmit at least one signal 114a, 114b from the transmit antenna 106a, 106b. The receiver 104 is configured to receive and process the signals 114a, 114b for, among other things, determining the geolocation of the receiver 104 or receiving other information from the satellite platforms 102a, 102b.

The range distances of the signals 114a, 114b can change with respect to the receiver 104, depending on the orientation and position of the transmit antennas 106a, 106b with respect to the receive antenna 112. Furthermore, the range distances of the signals 114a, 114b can change continuously as the satellite platforms 102a, 102b move relative to the receiver 104, which induces a propagation delay as well as a Doppler shift.

The receiver 104 has the ability to measure the range of the signals 114a, 114b to very fine resolution. Often measurement noise of only a few millimeters is possible for a GPS carrier phase, while tens of centimeters can be achieved in the GPS code phase (pseudo-range) measurement. This level of accuracy is sufficient for the receiver 104 to observe the time offset and Doppler shift of the signals 114a, 114b as the satellite platforms 102a, 102b change orientation with respect to the location of the receiver 104. Note that the signals 114a, 114b can be received at the receiver 104 contemporaneously (overlapping in time). Such contemporaneous reception of the signals 114a, 114b is also referred to as a multi-burst signal. Therefore, the receiver 104 must be able to discriminate the signals 114a, 114b from each other as well as from contemporaneous signals and noise received from other sources.

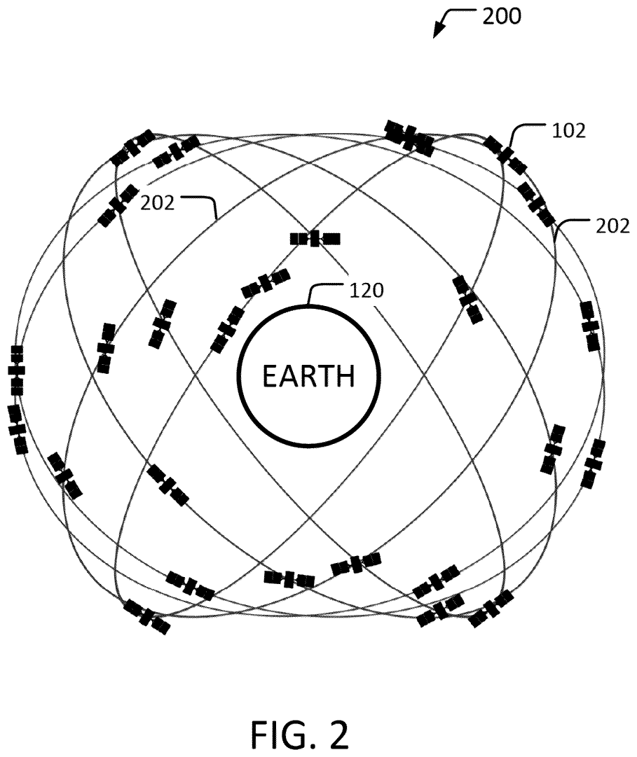

FIG. 2 depicts a constellation 200 of satellites in Earth orbit. Each of the satellites follows an orbital path 202 around the Earth 120. Different satellites may follow different orbital paths. In some examples, an Earth coverage broadcast antenna (e.g., the transmit antenna 106a, 106b) creates a planet-shaped gain pattern to achieve uniform signal power distribution at all points visible to the receive antenna 112 from the Earth 120. At least some of the satellite signals, such as the Earth coverage signals transmitted from the transmit antenna 106, are formed to be broadly visible over as much of the surface of the Earth 120 as possible. The receiver 104 can track such broadly visible signals (e.g., the signals 114a, 114b) anywhere above 5° Earth horizon and maintain lock on the signals until the satellite platforms 102a, 102b set below approximately the same elevation. Thus, the ability of the receiver 104 to acquire and track the signals depends on the orbital paths 202 of the satellite platforms 102a, 102b. As used herein, the phrase “orbital location” includes a location of a satellite along the orbital path 202 relative to a given point on or above the Earth 120, such as the location of the receiver 104 or another point of reference. Other signals broadcast from the satellite platforms 102a, 102b may not be as broadly visible from the Earth 120, but in any event are visible over at least a portion of the orbital path 202.

Receiver with Signal Acquisition Search Engine

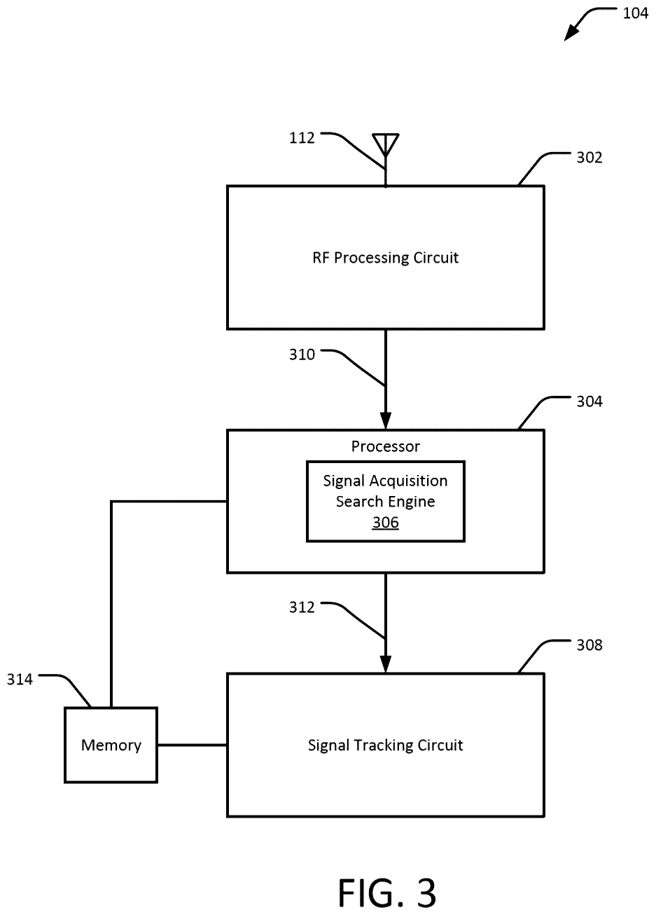

FIG. 3 is a block diagram of the receiver 104, in accordance with an example of the present disclosure. The receiver 104 includes, or is operatively coupled to, the antenna 112. The receiver 104 includes a radio frequency (RF) processing circuit 302, a processor 304, such as an application-specific integrated circuit (ASIC) or a field programmable gate array (FPGA) having a signal acquisition search engine 306, and a signal tracking circuit 308.

The RF processing circuit 302 is configured to provide the signals 114a, 114b from the receive antenna 112 to the processor 304. For example, the RF processing circuit 302 can include an RF downconverter, an analog-to-digital signal converter/sampler, and a digital signal processor. The RF processing circuit 302 thus converts the RF signals (e.g., the signals 114a, 114b) from analog to a sampled digital signal 310 for further processing by the processor 304. The sampled digital signal 310 can be a complex signal, also referred to as an in-phase/quadrature (IQ) signal. The signals 114a, 114b include a code that uniquely identifies a satellite (e.g., the satellite platforms 102a, 102b) transmitting the signals 114a, 114b from the transmit antennas 106a, 106b onboard the satellites. It will be understood that the RF processing circuit 302 can be further configured to process other signals received via the receive antenna 112 from additional satellites.

The processor 304 is configured to receive the sampled digital signal 310 and to produce an output signal 312 for further processing by the signal tracking circuit 308. The output signal 312 can include, for example, a magnitude of a peak bin (tone), adjacent bin magnitudes, received signal strengths, and/or a memory pointer into a memory 314 configured to store the sampled digital signal 310. As will be described in further detail below, the signal acquisition search engine 306, which is integrated into the processor 304, uses a correlation-based computation to detect the presence of a signal with a known or pre-determined form or code within the sampled digital signal 310. Correlation is the process of measuring the similarity between the sampled digital signal 310, which is incoming to the receiver 104, and a set of known signals, also referred to herein as tones and codes. Such correlation detection is useful for acquiring signals in environments where multiple signals are received contemporaneously and where the signals of interest may be obscured by noise and Doppler effects.

In general, the correlation is a value representing the product of the sampled digital signal 310 (which is unknown) and one or more generated tones and/or codes summed over an interval. The correlation value thus represents the similarity of the sampled digital signal 310 to the tones and codes, where low correlation values (e.g., approaching zero) represent dissimilar signals that are unlikely to be signals of interest for acquisition, and high correlation values represent higher levels of similarity that are more likely to be signals of interest for acquisition.

In a first stage of processing, a running, or sliding window, correlation is performed to accommodate time delays and Doppler shifts in the sampled digital signal 310, which may include multiple bursts. The resulting correlation values having magnitudes exceeding a pre-defined threshold, which can be a function (e.g., a multiple) of a noise estimate, are then sorted to identify one or more candidates signals from the sampled digital signal 310 having the highest correlation values for further processing by a second stage of processing. The number of tones in the first stage is governed by the clock rate of the processor 304 and the incoming sample rate. The PDI of the correlation is not governed by clock rates in the first stage.

In a second stage of processing, the candidate signals are again correlated against interpolated tones corresponding to the one or more candidate signals identified by the first stage, where the number of signal samples is governed by the clock rate of the processor 304 and the incoming sample rate. The candidate signals are also correlated against a set of code signals that represent data encoded (or expected to be encoded) in the candidate signals. The PDI interval of the second stage can be larger than the PDI interval of the first stage for better detection. The resulting second stage correlation values having magnitudes exceeding a pre-defined threshold, which can also be a function of the noise estimates from the first stage, are then sorted to identify signals having the highest correlation values for output to the signal tracking circuit 308 for further processing, such as acquisition and tracking. The signal tracking circuit 308 can, for example, be configured to track frequency, phase, and delay using a frequency locked loop (FLL), a phase locked loop (PLL), or using other tracking techniques.

In this manner, the signal acquisition search engine 306 can process many types of waveforms from alternate sources or signals of opportunity. The signal acquisition search engine 306 can work with embedded software defined radio (SDR) capabilities within the processor 304, which allows size, weight, power, and cost reductions. The signal acquisition search engine 306 also permits adjustments to the sample rate, the Doppler search range and granularity, and the PDI intervals, which can be independently configured for the first and second stages, to minimize implementation loss and false alarm rate while preventing missed detections.

### Signal Acquisition Search Engine

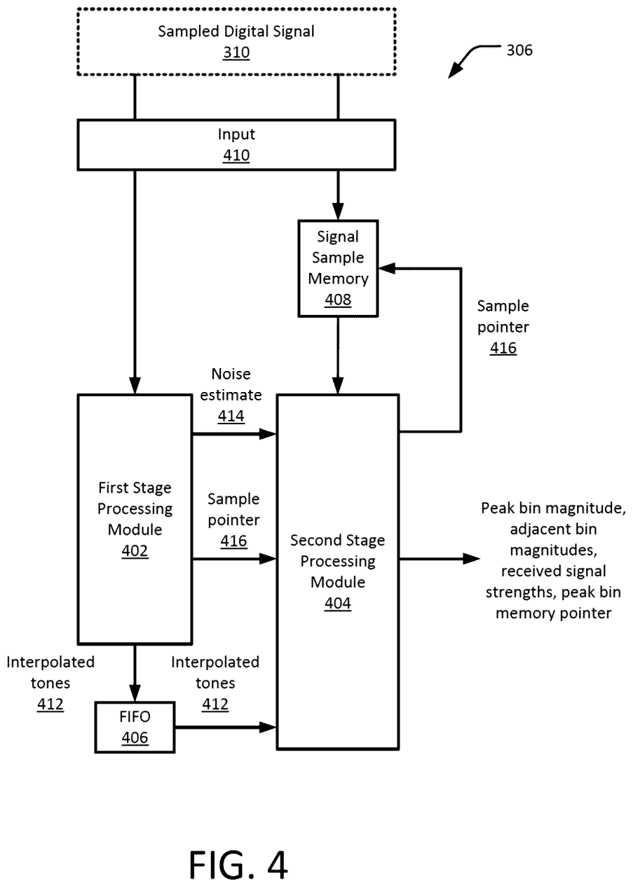

FIG. 4 is a block diagram of the signal acquisition search engine 306, in accordance with an example of the present disclosure. The search engine 306 includes a first stage processing module 402, a second stage processing module 404, a FIFO 406, and a signal sample memory 408. The first stage processing module 402 and signal sample memory 408 are each configured to receive an input 410 with radio frequency (RF) signal samples (e.g., the sampled digital signal 310 from the RF processing circuit 302). The signal acquisition search engine 306 can be used to correlate and search across a range of Doppler shift frequencies and time offsets using software-defined signal patterns (codes). When candidate signals (tones) are found, their time and Doppler offsets are written to an indexed memory buffer for further processing (e.g., signal acquisition and tracking).

The first stage processing module 402 is configured to correlate a first set of the RF signal samples to a set of generated tones with arbitrary spacing. For example, the correlation includes performing pre-detection integration (PDI), which is a sum of each generated tone multiplied by each of the signal samples. The tones are generated to produce a Doppler spectrum from the RF signal samples. As described in further detail below, in some examples, the first stage processing module 402 includes one integrator per generated tone, where the number of integrations equals the number of PDI intervals. For example, such as shown in FIG. 8, the number of PDI intervals can be 620 for a sample rate of 125,000 samples per second, 744 for a sample rate of 150,000 samples per second, and 868 for 175,000 samples per second.

The correlation performed by the first stage processing module 402 is a sliding window correlation, where correlation values from the earliest RF signal sample in the sliding window are removed or subtracted from the integrator for each generated tone and the correlation values from the latest RF signal sample in the sliding window are added to the integrator on a continuous basis.

The first stage processing module 402 is further configured to output, to the FIFO 406, a set of interpolated tones 412 representing Doppler estimates, each tone having first correlation magnitudes exceeding a first threshold value. The interpolated tones 412 are candidates for further processing by the second stage processing module 404. The first threshold value can be, for example, a multiple of a noise estimate 414 of the RF sample signals. The first stage processing module 402 also outputs the noise estimate 414 to the second stage processing module 404 and a sample pointer 416 to the signal sample memory 408, which is configured to store the RF signal samples from the input 410. The sample pointer 416 is a pointer to a location in the signal sample memory 408 where one or more of the RF signal samples corresponding to the interpolated tones 412 is stored (e.g., a signal time-of-arrival pointer, where the RF sample signals are stored in the signal sample memory 408 according to their respective times of arrival at the receiver 104). The first stage processing module 402 does not directly provide the RF signal samples to the second stage processing module 404, but instead provides the sample pointer 416 to the second stage processing module 404 so that the second stage processing module 404 can retrieve the RF signal samples referenced by the sample pointer 416 from the signal sample memory 408.

The second stage processing module 404 is configured to correlate a second set of the RF signal samples corresponding to the interpolated tones 412 to a set of code signals, such as a binary phase-shift keying (BPSK) code (e.g., a preamble code). As noted above, the second set of RF signal samples correlated in the second stage processing module 404 can be of any length, such as shorter or longer than those used in the first stage processing module 402. That is, the second stage processing module 404 correlates the RF signal samples referenced by the sample pointer 416 and the interpolated tones 412 with a set of code signals that are expected to be received with the RD signal samples. The resulting correlation values represent the similarity of the RF signal samples to the code signals at the generated tone frequencies. As described in further detail below, the second stage processing module 404 generates a set of tones that corresponds to the interpolated (candidate) tones and tones on either side of the interpolated tones, which represent candidate signals that are likely to be signals of interest for acquisition and that have a frequency range that is narrower than the set of tones generated by the first stage processing module 402.

For example, the correlation includes performing pre-detection integration (PDI), which as noted above is a sum of each generated tone multiplied by each of the signal samples and further multiplied by the code signals. As described in further detail below, in some examples, the second stage processing module 404 includes one integrator per generated tone, where the number of integrations equals the number of PDI intervals. For example, such as shown in FIG. 9, the number of PDI intervals can be 270 for a sample rate of 125,000 samples per second, 186 for a sample rate of 150,000 samples per second, and 135 for 175,000 samples per second for a maximum of five generated tones (based on the interpolated tones 412 from the first stage processing module 402).

The second stage processing module 404 is further configured to output a set of output tones each having second correlation magnitudes exceeding a second threshold value. The second threshold value may be different from the first threshold value. The output tones represent those RF signal samples that highly correlate to the code signals and can be used by the signal tracking circuit 308 to acquire and further process the RF signals of interest. The signal acquisition search engine 306 operates in real time, constantly searching in time and the full Doppler search range.

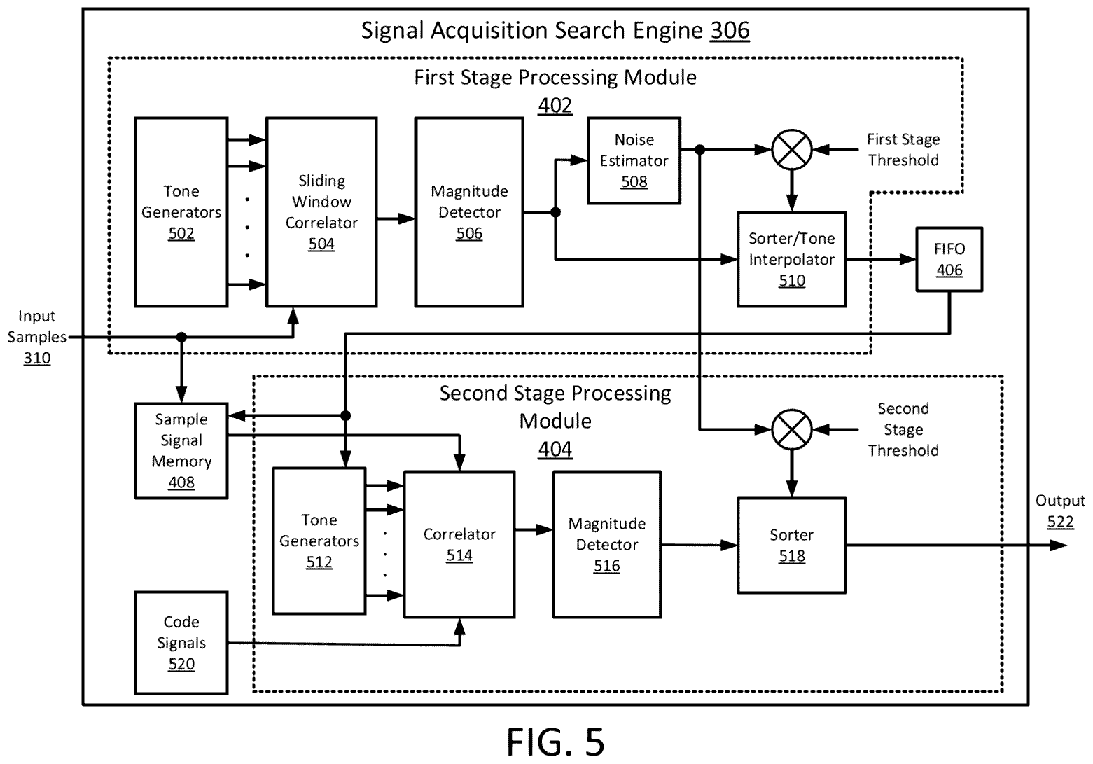

FIG. 5 is a more detailed block diagram of the signal acquisition search engine 306, in accordance with an example of the present disclosure. The first stage processing module 402 of the signal acquisition search engine 306 includes a first set of tone generators 502, a sliding window correlator 504, a magnitude detector 506, a noise estimator 508, and a sorter/tone interpolator 510. The second stage processing module 404 of the signal acquisition search engine 306 includes a second set of tone generators 512, a correlator 514, a magnitude detector 516, and a sorter 518. The signal acquisition search engine 306 is designed for signals that have a tone preamble followed by BPSK data modulated tones and can search a large Doppler range with arbitrary tone spacing.

The first stage processing module is configured to correlate the RF signal samples to the generated tones. The number of the tone generators 502 and the spacing between the generated tones can be configured in software, such as shown in FIG. 8. The sliding window correlator 504 correlates each of the generated tones with each of the input samples. The tone correlation is achieved by integrating the tones and samples over a sliding PDI interval in which the correlation values of the most recent input sample are added to a running total for each integrator while the correlation values from the earliest sample in the PDI interval are subtracted from the running total for each integrator. Thus, each successive PDI interval adds the most recent correlation values and subtracts the oldest correlation values on a continuous basis. The sliding window increases the efficiency of the correlation because the length of the correlation is constant and thus does not increase the processing load.

The magnitude detector 506 uses a coordinate rotation digital computer (CORDIC) algorithm to compute the magnitudes of each correlation value across all Doppler tones for each input signal. Correlation magnitudes approaching one represent greater similarities between the input samples and the tones than correlation values approaching zero. The magnitudes of each correlation value are sent to the sorter/tone interpolator 510, which sorts the correlation values. Correlation values that exceed a first stage threshold value are interpolated into candidates signals represented by tones, and the candidates are stored in the FIFO 406. The first stage threshold value can, for example, be a multiplier ⊗ of a noise estimate of the average of all correlation values in a given PDI interval.

The first stage processing module 402 runs independently of the second stage processing module 404. Both the first stage processing module 402 and the second stage processing module ingest the input samples; however, the second stage processing module 404 uses the interpolated (candidate) tones generated by the first stage processing module 402, which are stored in the FIFO 406, to generate tones with smaller spacing for further correlation.

If the second stage processing module 404 cannot keep pace with the first stage processing module 402 (e.g., the FIFO 406 becomes full before the second stage processing module 404 can process the first-out data), the correlation values with the lowest magnitudes (e.g., the weakest correlations in the FIFO 406) can be preemptively removed from the FIFO 406 to prevent loss of information representing the strongest correlations.

The second stage processing module 404 takes the interpolated (candidate) tones from the FIFO 406 and then generates, using the tone generators 512, tones at the interpolated (center) tone frequency and at two tone frequencies on either side of the center tone. The tone spacing is software configurable. In some examples, all of the tones generated by the second stage processing module 404 can be within the tone spacing range of the first stage processing module 402. The correlator 514 is configured to correlate the input signal samples corresponding to the interpolated tones (from the first stage processing module 402) to the generated tones and to a set of code signals 520. If the magnitude detector 516 detects a magnitude of the correlation values (also computed via CORDIC) above a second stage threshold, that correlation value is passed into the sorter 518. The second stage threshold value can, for example, be a multiplier ⊗ of the noise estimate produced by the noise estimator 508. The maximum magnitude of all the tones is then output at 522 for further processing (e.g., for signal acquisition and tracking by the signal tracking circuit 308).

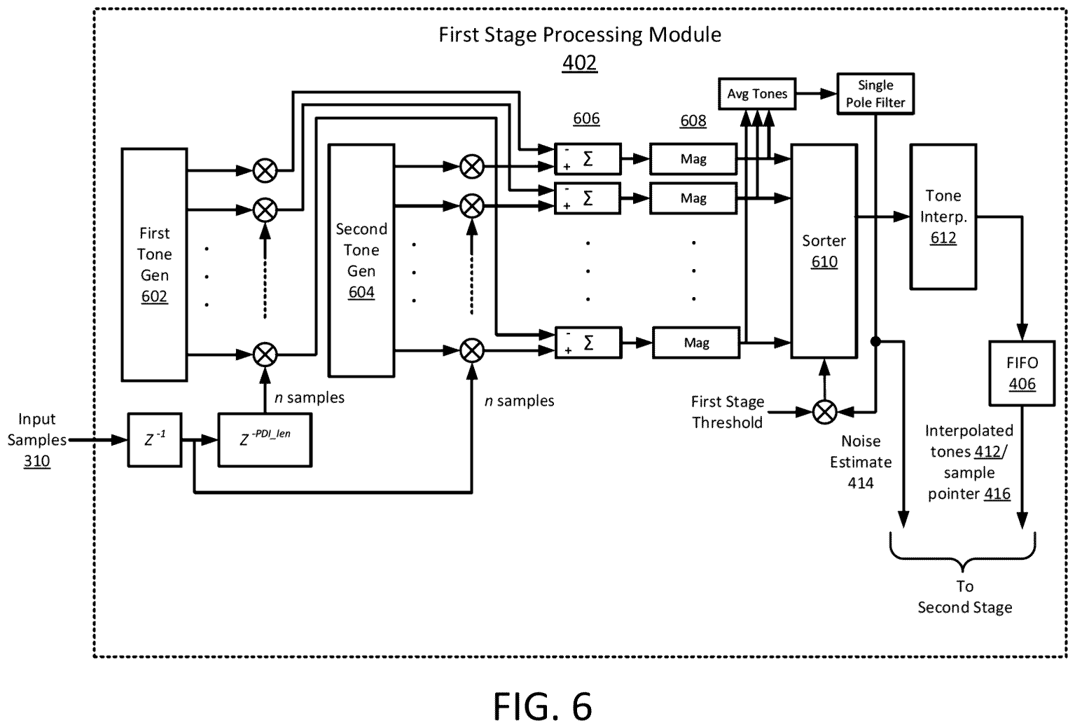

FIG. 6 is a schematic diagram of the first stage processing module 402, in accordance with an example of the present disclosure. The tone generators 502 of FIG. 5 can be implemented as a first tone generator 602 and a second tone generator 604. The first tone generator 602 generates a set of tones (e.g., tones defined by

$${e}^{j 2 π ( n - \frac{{PDI}_{l e n}}{{F}_{S}} ) {f}_{r} / N} ,$$

where r is the number of generated Doppler tones) that are delayed by the number of samples in a PDI interval (consecutive samples of the RF input signal to be integrated) in the PDI sliding window interval. The second tone generator 604 generates a set of tones (e.g., tones defined by e^{j2πf}^{ᵣ}^{/N}) that are not delayed relative to the first tone generator samples. Correlation is performed by subtracting, from each of a set of tone integrators 606, a pre-detection integration of the delayed first RF signal sample (e.g., the sample occurring at a beginning of a PDI interval window) and a respective one of the generated tones, and adding, to each of the tone integrators 606, a pre-detection integration of the delayed second RF signal sample (e.g., the sample occurring at an end of the PDI interval window) and the respective one of the generated tones. The tone integrators 606 each output a correlation value corresponding to the respective generated tone.

The magnitude detector 506 of FIG. 5 includes a set of magnitude detectors 608, one for each of the tone integrators 606, each of which detects the magnitude of the correlation values output by the respective tone integrators 606. The sorter/tone interpolator 510 of FIG. 5 can be implemented as sorter 610 and tone interpolator 612. In more detail, the sorter 610 sorts the correlation values and outputs values exceeding a first stage threshold to the tone interpolator 612. The first stage threshold value can be a multiplier of the noise estimate produced by the noise estimator 508, which in this example is an average of all the correlation values passed through a single pole filter.

The tone interpolator 612 computes the interpolated tones based on a Doppler frequency shift of at least two of the generated tones having at least two greatest correlation magnitudes exceeding the first threshold value. The tone interpolator 612 can, for example, use a formula to obtain a greater frequency resolution over a smaller region (which includes potential signals of interest) than the generated tones provide, such as by combining the correlation (DFT) values exceeding the first threshold value. The interpolated tones 412 are stored in the FIFO 406 along with the sample pointer 416. The sample pointer 416 is a pointer to a location in the signal sample memory 408 where one or more of the RF signal samples corresponding to the interpolated tones 412 is stored (e.g., a signal time-of-arrival pointer, where the RF sample signals are stored in the signal sample memory 408 according to their respective times of arrival at the receiver 104).

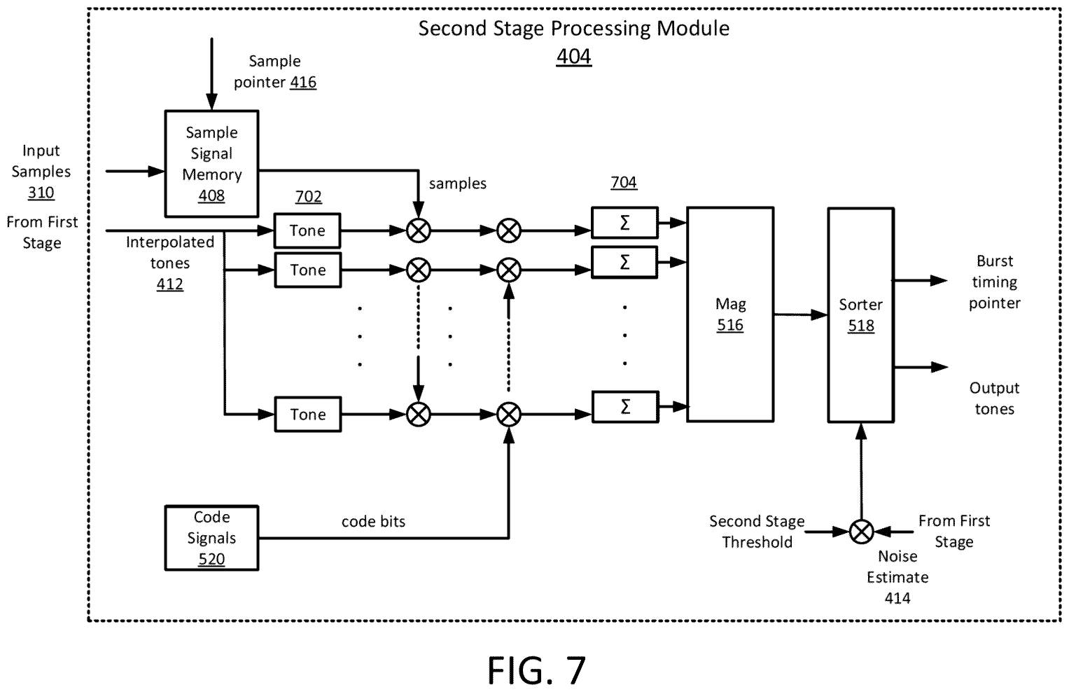

FIG. 7 is a schematic diagram of the second stage processing module 404, in accordance with an example of the present disclosure. The tone generators 512 of FIG. 5 can be implemented as a set of tone generators 702 each generating a tone (e^{j2π(f}^{_{p+Dop}}^{)/N}, where p is the number of generated Doppler tones and Dop is the Doppler candidate tone from the FIFO 406) that is multiplied by the input sample corresponding to the sample pointer 416 from the first stage processing module 402.

Correlation is performed by summing, from each of a set of tone integrators 702, a pre-detection integration of each of the sampled digital signals 310 stored in the sample signal memory 408 at a location corresponding to the pointer and a respective one of the generated tones, and one or more code signals 520 into each of a set of tone integrators 704. The tone integrators 704 each output a correlation value corresponding to the respective generated tone.

The magnitude detector 516 of FIG. 5 detects the magnitude of the correlation values output by the respective tone integrators 704 using a CORDIC algorithm. The sorter 518 sorts the correlation values and outputs values exceeding a second stage threshold. The second stage threshold value can be a multiplier of the noise estimate produced by the noise estimator 508 in the first stage processing module 402. The sorter 518 outputs the center tone and two adjacent tones on either side of the center tone, as well as a pointer into the memory 314, which is configured to store the sampled digital signal 310 corresponding to the center tone and adjacent tones.

In some examples, one or more of the following parameters is software configurable: a rate at which the RF signal samples are received, a symbol length of each of the PDI intervals, a time length of each of the PDI intervals, a maximum number of the generated tones, a frequency spacing between each of the generated tones, a maximum number of the RF signal samples in each of the PDI intervals, a maximum number of symbols in each of the PDI intervals, and a frequency spacing between each of the interpolated tones and two adjacent tones on either side of the interpolated tones. FIG. 8 is a table showing examples of some configurable parameters for the first stage processing module 402, and FIG. 9 is a table showing examples of some configurable parameters for the second stage processing module 404.

Falsing Reduction with Frequency Pruning Window

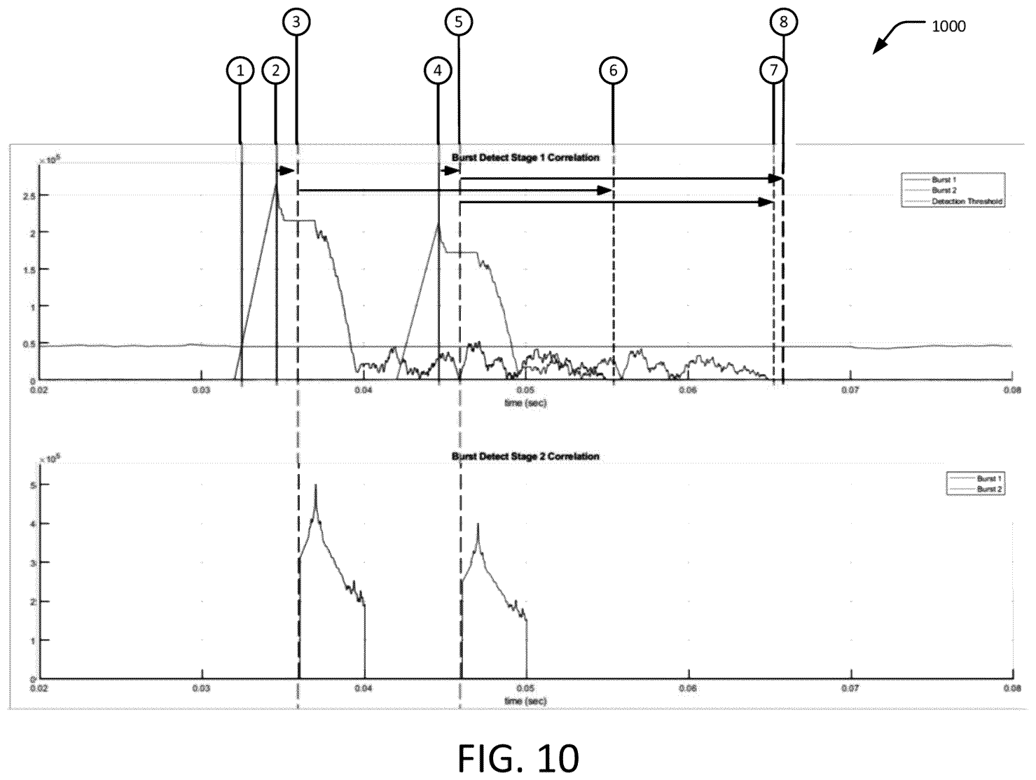

In some examples, the signal acquisition search engine 306 utilizes frequency pruning coupled with a frequency pruning window to reduce processing of weaker (false) signals, such as described with respect to FIG. 10. The signal acquisition search engine 306 eliminates false candidates by ignoring new candidates that arrive within a certain time (the frequency pruning window) of the candidate signal.

FIG. 10 is a graph 1000 showing two signal burst correlations (for Burst 1 and Burst 2) over time, in accordance with an example of the present disclosure. The graph 1000 shows the correlated magnitude of the signal burst on the vertical axis and the time of the signal burst on the horizontal axis. At time (1), the magnitude of a bin of Burst 1 exceeds the first stage (correlation detection) threshold value within the first stage processing module 402 and the signal is fed into the sorter 610.

As noted above, in some examples, the first stage threshold value can be a multiplier of the noise estimate produced by the noise estimator 508, which can be an average of all the correlation values passed through a single pole filter. However, as the noise estimate—and thus the threshold—rises, the risk of missing a signal burst also increases unless the noise estimate is further refined. To this end, in an example, at time (1), the output of the noise estimator 508 (e.g., an infinite impulse response or IIR filter) is temporarily frozen so that signal bursts do not artificially raise the estimated noise floor, potentially causing missed detections.

Between time (1) and time (2) each magnitude of the signal samples is greater than before and thus the signal is fed into the sorter 610. At time (2) the magnitude of Burst 1 reaches a peak value. A programmable waiting period between time (2) and time (3) is used to ensure that the peak value of burst 1 is truly a peak (and not followed by a higher value within that period). One a magnitude has been in the sorter 610 for at least, e.g., 100 samples, the magnitude is determined to be a peak and put into the FIFO 406. If Burst 1 does not exceed the peak measured at time (2), then at time (3) Burst 1 is stored in the FIFO 406 and a noise hold counter is reset so that the noise energy estimate output by the noise estimator 508 will be frozen from this point for a programmable period of time (e.g., from time (3) to time (8)). The counter is reset each time a new signal is put into the FIFO 406.

From time (3) to time (6), the sorter 610 performs frequency pruning on any new signal bursts that occur within a programmable range of frequency bins from the first burst (e.g., the frequency of Burst 1). That is, any other signals that are received between time (3) and time (6) in the range of frequency bins from Burst 1 are ignored by the sorter 610 if the magnitude of those signals are below the peak of Burst 1. The time between time (3) and time (6) is referred to as a frequency pruning window, which can last for the length of the entire signal burst. At time (6), Burst 1 is removed from the sorter 610 and no further frequency pruning of new signal candidates after time (6) will be performed against Burst 1.

Times (4) and (5) are similar to times (2) and (3) but for second candidate burst, e.g., Burst 2. At time (7), Burst 2 is removed from the sorter 610 and no further frequency pruning of new candidates will be done against Burst 2.

At time (8), the output of the noise estimator 508 is un-frozen and can again adapt to the correlation values in the first stage processing module 402.

Any stronger candidate bursts occurring between times (2) and (3) within the frequency pruning window will replace the burst in the sorter 610 to be sent to the FIFO 406. Stronger candidate bursts after time (3) within the frequency pruning window will be sent to the FIFO 406 to be subsequently processed by the second stage processing module 404. If the second stage processing module 404 detects both the initial burst and the subsequent bursts after time (3) with higher peaks, all of these bursts will be correlated and output by the second stage processing module 404 at output 522.

FIG. 11 is a flow diagram of a frequency pruning process 1100, in accordance with an example of the present disclosure. The frequency pruning process 1100 occurs between time (3) and time (6) and between time (5) and time (7) in the above example of FIG. 10.

At block 1102, an incoming bin magnitude estimate from a signal burst is compared to the first threshold value of the first stage processing module 402. The first threshold value can be a fixed threshold or an adaptive threshold, which is software selectable via a switch 1104. If the incoming bin magnitude exceeds the first threshold value, it is considered a new candidate signal for the signal acquisition search engine 306.

At block 1106, if the new candidate signal is not within a frequency pruning range, then the new candidate signal is logged in the sorter 610 as a candidate signal at block 1108. The frequency pruning range is a number of bins on either side of a bin having the maximum magnitude of the signal burst. The frequency pruning range is adjustable. In some examples, the frequency pruning range is three bins.

If the new candidate signal is not within the frequency pruning range (that is, within the frequency pruning range of the existing candidate signal that was logged in the sorter 610), then the magnitude of the new candidate signal is evaluated at block 1110. If the magnitude of the new candidate signal is not greater than, or equal to, the maximum magnitude of the signal burst, then the new candidate signal is ignored at block 1112. If the new candidate signal is greater than the maximum magnitude of the signal burst and is within the frequency pruning window (block 1114), then the new candidate signal is logged in the sorter 610 as a candidate signal at block 1108. Otherwise, at block 1116 the existing candidate signal in the sorter 610 is overwritten with the new candidate signal and a noise hold counter is reset.

At block 1118, if the age of the new candidate signal is equal to the length of the signal burst, then the existing candidate signal in the sorter 610 is sent to the FIFO 406 at block 1120 and a new pruning window begins. Otherwise, at block 1122, if the age of the new candidate signal is equal to the frequency pruning window, then the new candidate signal is cleared from the list of candidate signals I the sorter 610.

In this manner, the process 1100 eliminates false candidates by frequency pruning new candidates that arrive within a certain time (a frequency pruning window) of the candidate signal.

### Second Stage Window Size

As noted above, if the magnitude detector 516 of the second stage processing module 404 detects a magnitude of the correlation values above a second stage threshold, that correlation value is passed into the sorter 518. The maximum magnitude of all the tones is then output at 522 for further processing (e.g., for signal acquisition and tracking by the signal tracking circuit 308). The sorter 518 of the second stage processing module 404 runs for a fixed number of samples. However, the SDR can be configured in software to use a different window length (per signal) based on the peak magnitude of the candidate signal in the first stage processing module 402. Since the first stage processing module 402 provides a better time of arrival accuracy at higher carrier-to-noise (CN₀) ratios, the search space of second stage processing module 404 can be reduced accordingly. The number of taps in the time search space performed by the second stage processing module 404 affects the overall system performance and the number of possible time of arrival/Doppler hypotheses that can be processed.

In an example, several (e.g., four) magnitude/window length pairs can be written into a memory map to be used as a lookup table by the second stage processing module 404. This optimizes the resources of the second stage processing module 404 so that potentially more signal bursts can be processed. For example:

| | Magnitude | Window Length | Window Offset |
|---|---|---|---|
| CN₀ Range (dB Hz) | Threshold | (samples) | (samples) |
| 0-42 | 0 | 300 | 568 |
| 42-45 | 3500 | 150 | 718 |
| 45-55 | 4700 | 80 | 788 |
| 55-68 | 10000 | 30 | 838 |

### Adapting First Stage Threshold Based on FIFO Depth

In accordance with an example of the present disclosure, the first stage processing module 402 limits the number of possible signals for the second stage processing module 404 to examine. If candidate signals in the FIFO 406 are being dropped before the second stage processing module 404 can process them (e.g., due to the FIFO 406 overflowing), then the first stage processing module 402 should reduce the number of candidate signals sent to the FIFO 406 by screening them more aggressively. Conversely, if the second stage processing module 404 is idle, either there are simply no signals to detect, or the first stage processing module 402 is screening results too aggressively. To reach a balance, the first threshold value of the first stage processing module 402 can be dynamically adapted based on the depth of the FIFO 406 (i.e., the number of candidate signals stored in the FIFO 406 at any given time). The depth of the FIFO 406 is reported to software, which dynamically changes the first threshold value of the first stage processing module 402 to increase or decrease the number of samples exceeding the first threshold based on the depth of the FIFO 406, and thus processed into the FIFO 406.

### Example Methodology

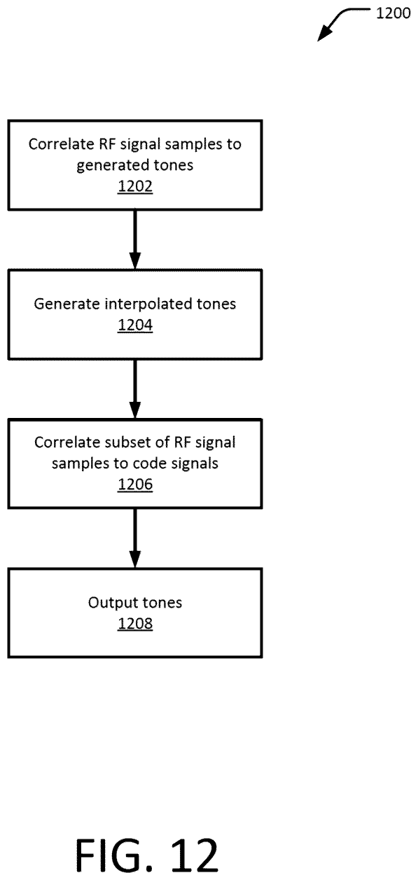

FIG. 12 is a flow diagram of an example method 1200 for signal acquisition, in accordance with an example of the present disclosure. The method 1200 can be implemented, for example, in the receiver 104 of FIG. 1. The method 1200 includes correlating 1202 a first set of radio frequency (RF) signal samples to a plurality of generated tones. The number and spacing of the generated tones can be software configurable, such as shown in FIG. 8. The method 1200 further includes generating 1204 a plurality of interpolated tones each having first correlation magnitudes exceeding a first threshold value. In some examples, the first threshold value is a function of a noise estimate of the RF signal samples. In some examples, the noise estimate is frozen beginning at a start of the programmable waiting period and ending at an end of the frequency pruning window, such as described with respect to FIG. 10. In some examples, the first set of RF signal samples having a magnitude below the peak magnitude of the correlated first set of RF signal samples occurring during the frequency pruning window are ignored and not correlated.

The method 1200 further includes correlating 1206 a second set of RF signal samples corresponding to the interpolated tones to a plurality of code signals. For example, the second set of RF signal samples are those RF signal samples that correspond to the tones, or interpolated tones, that have correlation values that exceed the first threshold value. The method 1200 further includes outputting 1208 a plurality of output tones each having second correlation magnitudes exceeding a second threshold value. In some examples, the second threshold value is a function of the noise estimate, and may be different from the first threshold value.

In some examples, correlating 1202 the RF signal samples to the plurality of generated tones includes subtracting, from each of a plurality of tone integrators, a pre-detection integration of a first RF signal sample and a respective one of the generated tones, and adding, to each of the tone integrators, a pre-detection integration of a second RF signal sample and the respective one of the generated tones. In such examples, the first RF signal sample occurs at a beginning of a pre-detection integration (PDI) interval window, and the second RF signal sample occurs at an end of the PDI interval window, where the PDI interval window includes a plurality of consecutive PDI intervals.

In some examples, the second set of RF signal samples corresponding to the at least one interpolated tone are correlated to a plurality of code signals using a window length based on a peak magnitude of the correlated first set of RF signal samples.

In some examples, the interpolated tones are center tones. The second set of RF signal samples corresponding to the center tones are correlated to two adjacent tones on either side of the center tones combined with the code signals. In some examples, a noise energy estimate is generated based on an average correlation magnitude of each of the RF signal samples, and the first threshold value is based at least in part on the noise energy estimate. In some examples, the first correlation magnitudes and the second correlation magnitudes are each computed for each of the tones using a CORDIC algorithm.

### Example Processing Platform

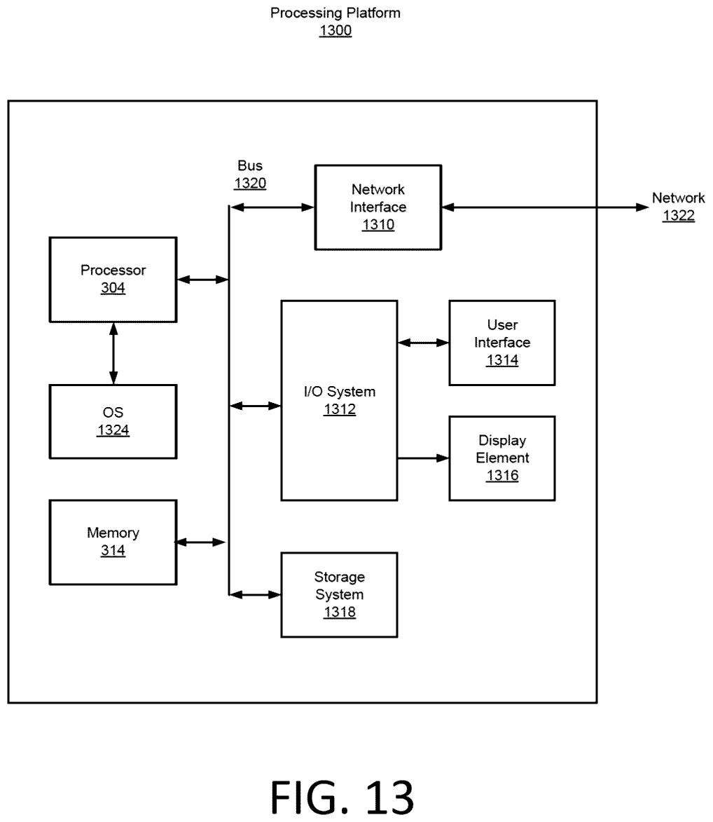

FIG. 13 is a block diagram of a processing platform 1300 configured to provide a system for multi-stage, multi-burst signal acquisition, in accordance with an example of the present disclosure. In some examples, the platform 1300, or portions thereof, can be hosted on, or otherwise be incorporated into the electronic systems of a satellite receiver, including data communications systems, radar systems, computing systems, or embedded systems of any kind. The disclosed techniques can also be used to improve the reliability of satellite signal acquisition in other platforms including data communication devices, personal computers, workstations, laptop computers, tablets, touchpads, portable computers, handheld computers, cellular telephones, smartphones, or messaging devices.

In an example, the platform 1300 includes any combination of the processor 304, the memory 314, a network interface 1310, an input/output (I/O) system 1312, a user interface 1314, a display element 1316, and a storage system 1318. For example, the platform includes the receiver 104 of FIG. 1, including the memory 314 and the processor 304 with the signal acquisition search engine 306 of FIG. 3. A bus and/or interconnect 1320 is provided to allow for communication between the various components listed above and/or other components of the platform 1300. The platform 1300 can be coupled to a network 1322 through the network interface 1310 to allow for communications with other computing devices, platforms, devices to be controlled, and/or other resources. Other componentry and functionality not reflected in FIG. 13 will be apparent in light of this disclosure, and it will be appreciated that other examples are not limited to any particular hardware configuration.

The processor 304 can be any suitable processor, and can include one or more coprocessors or controllers, such as an audio processor, a graphics processing unit, or hardware accelerator, to assist in the execution of mission software and/or any control and processing operations associated with the platform 1300. In some examples, the processor 304 is implemented as one or more processor cores. The processor core or cores can include any type of processor, such as, for example, a micro-processor, an embedded processor, a digital signal processor (DSP), a graphics processor (GPU), a network processor, a field programmable gate array (FPGA), or other computing or electronic device. The processor 304 can have multithreaded cores such that the processor 304 includes more than one hardware thread context or logical processor per core. In some examples, the processor 304 can be implemented as a complex instruction set computer (CISC) or a reduced instruction set computer (RISC) processor.

The memory 314 can be implemented using any suitable type of digital storage including, for example, a random-access memory (RAM). A random-access memory is any memory having storage locations, or cells, which can be read from and written to in any order. For example, the memory 314 can be implemented as a volatile memory device such as a RAM, dynamic RAM (DRAM), or static RAM (SRAM) device. The storage system 1318 can be implemented as a non-volatile storage device such as a hard disk drive (HDD), a solid-state drive (SSD), a universal serial bus (USB) drive, an optical disk drive, tape drive, an internal storage device, an attached storage device, flash memory, battery backed-up synchronous DRAM (SDRAM), and/or a network accessible storage device.

In some examples, the processor 304 can be configured to execute an Operating System (OS) 1324, which can, for example, include any suitable operating system, such as Google Android (Google Inc., Mountain View, CA), Microsoft Windows (Microsoft Corp., Redmond, WA), macOS (Apple Inc., Cupertino, CA), Linux, or a real-time operating system (RTOS). In some examples, the processor 304 is a special purpose device configured to perform one or more of the functions variously described herein.

The network interface circuit 1310 can be any network chip or chipset that provides wired and/or wireless connection between other components of the platform 1300 and/or the network 1322, thereby enabling the platform 1300 to communicate with other local and/or remote computing systems, and/or other resources. Wired communication can include, for example, Ethernet. Wireless communication can include cellular communications including LTE (Long Term Evolution) and 5G, Wireless Fidelity (Wi-Fi), Bluetooth, and/or Near Field Communication (NFC). Wireless networks can include, for example, wireless local area networks, wireless personal area networks, wireless metropolitan area networks, cellular networks, and satellite networks.

The I/O system 1312 can be configured to interface between various I/O devices and other components of platform 1300. I/O devices can include, for example, the user interface 1314 and the display element 1316. The user interface 1314 can include input/output devices such as a touchpad, keyboard, and mouse, etc., for example, to allow the user to interact with the platform 1300 or components of the platform 1300. The display element 1316 can, for example, be configured to display information to a user. The I/O system 1312 can include a graphics component configured render graphics on the display element 1316. The graphics component can include, for example, a graphics processing unit or a visual processing unit. An analog or digital interface can be used to communicatively couple graphics subsystem and the display element. For example, the interface can include a high definition multimedia interface (HDMI), DisplayPort, wireless HDMI, and/or any other suitable interface using wireless high definition compliant techniques. In some examples, the graphics subsystem can be integrated into the processor 102 or another component (e.g., a graphics chipset) of the platform 1300.

It will be appreciated that in some examples, the various components of the platform 1300 can be combined or integrated in a system-on-a-chip (SoC) architecture. In some examples, the components can be hardware components, firmware components, software components or any suitable combination of hardware, firmware, or software.

In some examples, the platform 1300 can be implemented as a wireless system, a wired system, or a combination of both. When implemented as a wireless system, the platform 1300 can include components and interfaces suitable for communicating over a wireless shared media, such as one or more antennae, transmitters, receivers, transceivers, amplifiers, filters, control logic, and so forth. An example of wireless shared media can include portions of a wireless spectrum, such as the radio frequency spectrum and so forth. When implemented as a wired system, the platform 1300 can include components and interfaces suitable for communicating over wired communications media, such as input/output adapters, physical connectors to connect the input/output adaptor with a corresponding wired communications medium, a network interface card (NIC), disc controller, video controller, audio controller, and so forth. Examples of wired communications media can include a wire, cable metal leads, printed circuit board (PCB), backplane, switch fabric, semiconductor material, twisted pair wire, coaxial cable, fiber optics, and so forth.

### XXX

Various examples of the present disclosure can be implemented using hardware elements, software elements, or a combination of both. Examples of hardware elements can include processors, microprocessors, circuits, circuit elements (for example, transistors, resistors, capacitors, inductors, and so forth), integrated circuits, ASICs, programmable logic devices, digital signal processors, FPGAs, logic gates, registers, semiconductor devices, chips, microchips, chipsets, and so forth. Examples of software can include software components, programs, applications, computer programs, application programs, system programs, machine programs, operating system software, middleware, firmware, software modules, routines, subroutines, functions, methods, procedures, software interfaces, application program interfaces, instruction sets, computing code, computer code, code segments, computer code segments, words, values, symbols, or any combination thereof. Determining whether an embodiment is implemented using hardware elements and/or software elements can vary in accordance with any number of factors, such as desired computational rate, power level, heat tolerances, processing cycle budget, input data rates, output data rates, memory resources, data bus speeds, and other design or performance constraints.

Some embodiments can be described using the expression “coupled” and “connected” along with their derivatives. These terms are not intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still cooperate or interact with each other.

Some examples disclosed herein can be implemented in various forms of hardware, software, firmware, and/or special purpose processors. For example, in one example, at least one non-transitory computer readable storage medium has instructions encoded thereon that, when executed by one or more processors, cause one or more of the methodologies disclosed herein to be implemented. The instructions can be encoded using a suitable programming language, such as C, C++, object oriented C, Java, JavaScript, Visual Basic .NET, Beginner's All-Purpose Symbolic Instruction Code (BASIC), or alternatively, using custom or proprietary instruction sets. The instructions can be provided in the form of one or more computer software applications and/or applets that are tangibly embodied on a memory device, and that can be executed by a computer having any suitable architecture. In one example, the system can be hosted on a given website and implemented, for example, using JavaScript or another suitable browser-based technology. For instance, in some examples, the platform 1300 can leverage processing resources provided by a remote computer system accessible via the network 1322. The computer software applications disclosed herein can include any number of different modules, sub-modules, or other components of distinct functionality, and can provide information to, or receive information from, still other components. These modules can be used, for example, to communicate with input and/or output devices such as a display screen, a touch sensitive surface, a printer, and/or any other suitable device. Other componentry and functionality not reflected in the illustrations will be apparent in light of this disclosure, and it will be appreciated that other examples are not limited to any particular hardware or software configuration. Thus, in some examples, the platform 1300 can include additional, fewer, or alternative subcomponents as those described above.

The non-transitory computer readable medium can include any suitable medium for storing digital information, such as a hard drive, a server, a flash memory, and/or random-access memory (RAM), or a combination of memories. In some examples, the components and/or modules disclosed herein can be implemented with hardware, including gate level logic such as a field-programmable gate array (FPGA), or alternatively, a purpose-built semiconductor such as an application-specific integrated circuit (ASIC). Still other examples can be implemented with a microcontroller having a number of input/output ports for receiving and outputting data, and a number of embedded routines for carrying out the various functionalities disclosed herein. It will be apparent that any suitable combination of hardware, software, and firmware can be used, and that other examples are not limited to any particular system architecture.

Some examples can be implemented, for example, using a machine readable medium or article that stores a set of instructions that, when executed by a machine, causes the machine to perform a method, process, and/or operations in accordance with the examples described herein. Such a machine can include, for example, any suitable processing platform, computing platform, computing device, processing device, computing system, processing system, computer, process, or the like, and can be implemented using any suitable combination of hardware and/or software. The machine readable medium or article can include, for example, any suitable type of memory unit, memory device, memory article, memory medium, storage device, storage article, storage medium, and/or storage unit, such as memory, removable or non-removable media, erasable or non-erasable media, writeable or rewriteable media, digital or analog media, hard disk, floppy disk, compact disk read only memory (CD-ROM), compact disk recordable (CD-R) memory, compact disk rewriteable (CD-RW) memory, optical disk, magnetic media, magneto-optical media, removable memory cards or disks, various types of digital versatile disk (DVD), a tape, a cassette, or the like. The instructions can include any suitable type of code, such as source code, compiled code, interpreted code, executable code, static code, dynamic code, encrypted code, and the like, implemented using any suitable high level, low level, object oriented, visual, compiled, and/or interpreted programming language.

Unless specifically stated otherwise, it will be appreciated that terms such as “processing,” “computing,” “calculating,” and “determining” refer to the action and/or process of a computer or computing system, or similar electronic computing device, that manipulates and/or transforms data represented as physical quantities (for example, electronic) within the registers and/or memory units of the computer system into other data similarly represented as physical entities within the registers, memory units, or other such information storage transmission or displays of the computer system.

The terms “circuit” or “circuitry” can include, for example, hardwired circuitry, programmable circuitry, such as computer processors comprising one or more individual instruction processing cores, state machine circuitry, and/or firmware that stores instructions executed by programmable circuitry. The circuitry can include a processor and/or controller configured to execute one or more instructions to perform one or more operations described herein. The instructions can be implemented as, for example, an application, software, firmware, etc., configured to cause the circuit or circuitry to perform any of the operations or functions described herein. Software can be implemented as a software package, code, instructions, instruction sets and/or data recorded on a computer-readable storage device. Software can be implemented to include any number of processes, and processes, in turn, can be implemented to include any number of threads, etc., in a hierarchical fashion. Firmware can be implemented as code, instructions or instruction sets and/or data that are hard-coded (e.g., nonvolatile) in memory devices. The circuit or circuitry can be implemented as part of a larger system, for example, an integrated circuit (IC), an application-specific integrated circuit (ASIC), a system-on-a-chip (SoC), desktop computers, laptop computers, tablet computers, servers, smartphones, etc. Other examples can be implemented as software executed by a programmable control device. In such cases, the terms “circuit” or “circuitry” are intended to include a combination of software and hardware such as a programmable control device or a processor capable of executing the software. As described herein, various examples can be implemented using hardware elements, software elements, or any combination thereof. Examples of hardware elements can include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, and/or chip sets.

### FURTHER EXAMPLE EXAMPLES

The following examples pertain to further examples, from which numerous permutations and configurations will be apparent.

Example 1 provides a signal acquisition device comprising a first stage processing module configured to correlate a first set of a plurality of radio frequency (RF) signal samples to a plurality of generated tones, and to output a plurality of interpolated tones each having first correlation magnitudes exceeding a first threshold value; and a second stage processing module configured to correlate a second set of the RF signal samples to a plurality of code signals, and to output a plurality of output tones each having second correlation magnitudes exceeding a second threshold value, wherein the second set of RF signal samples correspond to the interpolated tones.

Example 2 includes the subject matter of Example 1, wherein the first stage processing module is configured to correlate the first set of the RF signal samples to the plurality of generated tones by subtracting, from each of a plurality of tone integrators, a pre-detection integration of a delayed sample of a first RF signal and a respective one of the generated tones, and adding, to each of the tone integrators, a pre-detection integration of a sample of a second RF signal and the respective one of the generated tones, wherein the first RF signal sample occurs at a beginning of a pre-detection integration (PDI) interval window, wherein the second RF signal sample occurs at an end of the PDI interval window, and wherein the PDI interval window includes a plurality of consecutive PDI intervals.

Example 3 includes the subject matter of any one of Examples 1 and 2, wherein the first stage processing module is further configured to compute the interpolated tones based on a Doppler frequency shift of at least two of the generated tones having at least two greatest correlation magnitudes exceeding the first threshold value.

Example 4 includes the subject matter of any one of Examples 1-3, further comprising a first-in-first-out (FIFO) buffer, wherein the FIFO buffer is configured to store the interpolated tones output by the first stage processing module.

Example 5 includes the subject matter of any one of Examples 1-4, wherein the interpolated tones are center tones, wherein the second stage processing module is further configured correlate the second set of the RF signal samples corresponding to the center tones to two adjacent tones on either side of the center tones combined with the code signals, and wherein the output tones include the center tones and the two adjacent tones.

Example 6 includes the subject matter of any one of Examples 1-5, wherein the first stage processing module is further configured to generate a noise energy estimate based on an average correlation magnitude of each of the RF signal samples in the first set of RF signal samples, wherein the first threshold value is based at least in part on the noise energy estimate.

Example 7 includes the subject matter of any one of Examples 1-6, wherein the first stage processing module is further configured to compute the first correlation magnitudes for each of the plurality of generated tones using a coordinate rotation digital computer (CORDIC) algorithm, and wherein the second stage processing module is further configured to compute the second correlation magnitudes for each of the plurality of code signals using the CORDIC algorithm.

Example 8 includes the subject matter of any one of Examples 1-7, wherein the first stage processing module is further configured to output a pointer to a memory where the second set of the RF signal samples corresponding to the interpolated tones are stored, and wherein the second stage processing module is further configured to retrieve, from the memory, the second set of the RF signal samples based on the pointer.

Example 9 includes the subject matter of any one of Examples 1-8, further comprising an application-specific integrated circuit (ASIC) or a field-programmable gate array (FPGA), wherein a number of the generated tones is based on a clock rate of the ASIC or FPGA and a rate of the RF signal samples received by the ASIC or FPGA.

Example 10 includes the subject matter of any one of Examples 1-9, wherein the code signals include a binary phase-shift keying (BPSK) code.

Example 11 includes the subject matter of any one of Examples 1-10, wherein one or more of the following parameters is configurable: a rate at which the RF signal samples are received, a symbol length of each of the PDI intervals, a time length of each of the PDI intervals, a maximum number of the generated tones, a frequency spacing between each of the generated tones, a maximum number of the RF signal samples in each of the PDI intervals, a maximum number of symbols in each of the PDI intervals, and a frequency spacing between each of the interpolated tones and two adjacent tones on either side of the interpolated tones.

Example 12 provides a system for multi-stage, multi-burst signal acquisition, the system comprising an input configured to receive a plurality of radio frequency (RF) signal samples; a processor configured to (i) correlate a first set of the RF signal samples to a plurality of generated tones, and to output a plurality of interpolated tones each having first correlation magnitudes exceeding a first threshold value; and (ii) configured to correlate a second set of the RF signal samples corresponding to the interpolated tones to a plurality of code signals, and to output at least one output tone having a second correlation magnitude exceeding a second threshold value; and a signal tracking circuit configured to track frequency, phase, and/or delay of each of the RF signal samples corresponding to the at least one output tone.

Example 13 includes the subject matter of Example 12, wherein the processor is configured to correlate the RF signal samples to the plurality of generated tones by subtracting, from each of a plurality of tone integrators, a pre-detection integration of a first RF signal sample and a respective one of the generated tones, and adding, to each of the tone integrators, a pre-detection integration of a second RF signal sample and the respective one of the generated tones, wherein the first RF signal sample occurs at a beginning of a pre-detection integration (PDI) interval window, wherein the second RF signal sample occurs at an end of the PDI interval window, and wherein the PDI interval window includes a plurality of consecutive PDI intervals.

Example 14 includes the subject matter of any one of Examples 12 and 13, wherein the processor is further configured to compute the interpolated tones based on a Doppler frequency shift of at least two of the generated tones having at least two greatest correlation magnitudes exceeding the first threshold value.

Example 15 includes the subject matter of any one of Examples 12-14, further comprising a first-in-first-out (FIFO) buffer, wherein the FIFO buffer is configured to store the interpolated tones.

Example 16 provides a signal acquisition method comprising correlating a first set of a plurality of radio frequency (RF) signal samples to a plurality of generated tones; generating a plurality of interpolated tones each having first correlation magnitudes exceeding a first threshold value; correlating a second set of the RF signal samples corresponding to the interpolated tones to a plurality of code signals; and outputting a plurality of output tones each having second correlation magnitudes exceeding a second threshold value.

Example 17 includes the subject matter of Example 16, wherein correlating the first set of the RF signal samples to the plurality of generated tones comprises subtracting, from each of a plurality of tone integrators, a pre-detection integration of a first RF signal sample and a respective one of the generated tones; and adding, to each of the tone integrators, a pre-detection integration of a second RF signal sample and the respective one of the generated tones, wherein the first RF signal sample occurs at a beginning of a pre-detection integration (PDI) interval window, wherein the second RF signal sample occurs at an end of the PDI interval window, and wherein the PDI interval window includes a plurality of consecutive PDI intervals.

Example 18 includes the subject matter of any one of Examples 16 and 17, wherein the interpolated tones are center tones, wherein the method further comprises correlating the second set of the RF signal samples corresponding to the center tones to two adjacent tones on either side of the center tones combined with the code signals.

Example 19 includes the subject matter of any one of Examples 16-18, further comprising generating a noise energy estimate based on an average correlation magnitude of each of the RF signal samples in the first set of RF signal samples, wherein the first threshold value is based at least in part on the noise energy estimate.

Example 20 includes the subject matter of any one of Examples 16-19, further comprising computing the first correlation magnitudes for each of the first set of tones using a coordinate rotation digital computer (CORDIC) algorithm, and computing the second correlation magnitudes for each of the second set of tones using the CORDIC algorithm.

Example 21 provides a signal acquisition device comprising a first stage processing module configured to correlate a first set of radio frequency (RF) signal samples to a plurality of generated tones, identify a candidate RF signal sample among the correlated first set of RF signal samples based on a peak magnitude of the correlated first set of RF signal samples, the candidate RF signal sample having a first correlation magnitude exceeding a first threshold value, and output an interpolated tone based on the candidate RF signal sample; and a second stage processing module configured to correlate a second set of RF signal samples corresponding to the interpolated tone to a plurality of code signals, and to output an output tone having a second correlation magnitude exceeding a second threshold value.

Example 22 includes the subject matter of Example 21, wherein the first stage processing module is configured identify the candidate RF signal sample among the correlated first set of RF signal samples based on the peak magnitude of the correlated first set of RF signal samples occurring during a programmable waiting period, wherein the programmable waiting period begins at a time when the candidate RF signal sample reaches the peak magnitude.

Example 23 includes the subject matter of Example 22, wherein the first stage processing module is further configured to generate a noise energy estimate based on an average correlation magnitude of each of the first set of RF signal samples occurring prior to and during the programmable waiting period, and wherein the first threshold value is based at least in part on the noise energy estimate.

Example 24 includes the subject matter of any one of Examples 22 and 23, wherein the first stage processing module is configured to ignore any of the first set of RF signal samples having a magnitude below the peak magnitude of the correlated first set of RF signal samples occurring during a frequency pruning window beginning at an end of the programmable waiting period.

Example 25 includes the subject matter of Example 24, wherein the frequency pruning window is a length of a signal burst within the first set of RF signal samples.

Example 26 includes the subject matter of any one of Examples 21-25, wherein the second stage processing module is configured to correlate the second set of RF signal samples using a window length based on the peak magnitude of the correlated first set of RF signal samples.

Example 27 includes the subject matter of any one of Examples 21-26, further comprising an application-specific integrated circuit (ASIC) or a field-programmable gate array (FPGA), wherein a number of the generated tones is based on a clock rate of the ASIC or FPGA and a rate of the first set of RF signal samples received by the ASIC or FPGA.

Example 28 provides a signal acquisition device comprising a first stage processing module configured to correlate a first set of radio frequency (RF) signal samples to a plurality of generated tones, generate a noise energy estimate based on an average correlation magnitude of each of the first set of RF signal samples occurring prior to and during a programmable waiting period, identify a candidate RF signal sample among the correlated first set of RF signal samples based on a peak magnitude of the correlated first set of RF signal samples, the candidate RF signal sample having a first correlation magnitude exceeding a first threshold value based at least in part on the noise energy estimate, wherein the programmable waiting period begins at a time when the candidate RF signal sample reaches the peak magnitude, and output an interpolated tone based on the candidate RF signal sample; and a second stage processing module configured to correlate a second set of RF signal samples corresponding to the interpolated tone to a plurality of code signals, and to output an output tone having a second correlation magnitude exceeding a second threshold value.

Example 29 includes the subject matter of Example 28, wherein the first stage processing module is configured identify the candidate RF signal sample among the correlated first set of RF signal samples based on the peak magnitude of the correlated first set of RF signal samples occurring during the programmable waiting period.

Example 30 includes the subject matter of any one of Examples 28 and 29, wherein the noise energy estimate is frozen beginning at a start of the programmable waiting period and ending at an end of a frequency pruning window.

Example 31 includes the subject matter of any one of Examples 28-30, wherein the first stage processing module is configured to ignore any of the first set of RF signal samples having a magnitude below the peak magnitude of the correlated first set of RF signal samples occurring during a frequency pruning window beginning at an end of the programmable waiting period.

Example 32 includes the subject matter of Example 31, wherein the frequency pruning window is a length of a signal burst within the first set of RF signal samples.

Example 33 includes the subject matter of any one of Examples 28-32, wherein the second stage processing module is configured to correlate the second set of RF signal samples using a window length based on the peak magnitude of the correlated first set of RF signal samples.

Example 34 includes the subject matter of any one of Examples 28-33, further comprising an application-specific integrated circuit (ASIC) or a field-programmable gate array (FPGA), wherein a number of the generated tones is based on a clock rate of the ASIC or FPGA and a rate of the first set of RF signal samples received by the ASIC or FPGA.

Example 35 provides a signal acquisition device comprising a first stage processing module configured to correlate a first set of radio frequency (RF) signal samples to a plurality of generated tones, and output at least one interpolated tone based on the correlated first set of RF signal samples; and a second stage processing module configured to correlate a second set of RF signal samples corresponding to the at least one interpolated tone to a plurality of code signals using a window length based on a peak magnitude of the correlated first set of RF signal samples, and to output an output tone having a second correlation magnitude exceeding a second threshold value.

Example 36 includes the subject matter of Example 35, wherein the first stage processing module is configured to identify a candidate RF signal sample among the correlated first set of RF signal samples based on the peak magnitude of the correlated first set of RF signal samples, the candidate RF signal sample having a first correlation magnitude exceeding a first threshold value, and wherein the interpolated tone is based on the candidate RF signal sample.

Example 37 includes the subject matter of Example 36, wherein the first stage processing module is configured identify the candidate RF signal sample among the correlated first set of RF signal samples based on the peak magnitude of the correlated first set of RF signal samples occurring during a programmable waiting period, wherein the programmable waiting period begins at a time when the candidate RF signal sample reaches the peak magnitude.

Example 38 includes the subject matter of Example 37, wherein the first stage processing module is further configured to generate a noise energy estimate based on an average correlation magnitude of each of the first set of RF signal samples occurring prior to and during the programmable waiting period, and wherein the first threshold value is based at least in part on the noise energy estimate.

Example 39 includes the subject matter of any one of Examples 35-38, wherein the first stage processing module is configured to ignore any of the first set of RF signal samples having a magnitude below the peak magnitude of the correlated first set of RF signal samples occurring during a frequency pruning window beginning at an end of the programmable waiting period.

Example 40 includes the subject matter of Example 39, wherein the frequency pruning window is a length of a signal burst within the first set of RF signal samples.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be appreciated in light of this disclosure. The present disclosure should, therefore, be considered to encompass such combinations, variations, and modifications. It is intended that the scope of the present disclosure be limited not by this detailed description, but rather by the claims appended hereto. Future filed applications claiming priority to this application may claim the disclosed subject matter in a different manner and may generally include any set of one or more elements as variously disclosed or otherwise demonstrated herein.

What is claimed is:

1. A signal acquisition device comprising:
a first stage processing module configured to
correlate a first set of radio frequency (RF) signal samples to a plurality of generated tones,
identify a candidate RF signal sample among the correlated first set of RF signal samples based on a peak magnitude of the correlated first set of RF signal samples, the candidate RF signal sample having a first correlation magnitude exceeding a first threshold value, and
output an interpolated tone based on the candidate RF signal sample; and
a second stage processing module configured to correlate a second set of RF signal samples corresponding to the interpolated tone to a plurality of code signals, and to output an output tone having a second correlation magnitude exceeding a second threshold value.

2. The signal acquisition device of claim 1, wherein the first stage processing module is configured identify the candidate RF signal sample among the correlated first set of RF signal samples based on the peak magnitude of the correlated first set of RF signal samples occurring during a programmable waiting period, wherein the programmable waiting period begins at a time when the candidate RF signal sample reaches the peak magnitude.

3. The signal acquisition device of claim 2, wherein the first stage processing module is further configured to generate a noise energy estimate based on an average correlation magnitude of each of the first set of RF signal samples occurring prior to and during the programmable waiting period, and wherein the first threshold value is based at least in part on the noise energy estimate.

4. The signal acquisition device of claim 2, wherein the first stage processing module is configured to ignore any of the first set of RF signal samples having a magnitude below the peak magnitude of the correlated first set of RF signal samples occurring during a frequency pruning window beginning at an end of the programmable waiting period.

5. The signal acquisition device of claim 4, wherein the frequency pruning window is a length of a signal burst within the first set of RF signal samples.

6. The signal acquisition device of claim 1, wherein the second stage processing module is configured to correlate the second set of RF signal samples using a window length based on the peak magnitude of the correlated first set of RF signal samples.

7. The signal acquisition device of claim 1, further comprising an application-specific integrated circuit (ASIC) or a field-programmable gate array (FPGA), wherein a number of the generated tones is based on a clock rate of the ASIC or FPGA and a rate of the first set of RF signal samples received by the ASIC or FPGA.

8. A signal acquisition device comprising:
a first stage processing module configured to
correlate a first set of radio frequency (RF) signal samples to a plurality of generated tones,
generate a noise energy estimate based on an average correlation magnitude of each of the first set of RF signal samples occurring prior to and during a programmable waiting period,
identify a candidate RF signal sample among the correlated first set of RF signal samples based on a peak magnitude of the correlated first set of RF signal samples, the candidate RF signal sample having a first correlation magnitude exceeding a first threshold value based at least in part on the noise energy estimate, wherein the programmable waiting period begins at a time when the candidate RF signal sample reaches the peak magnitude, and
output an interpolated tone based on the candidate RF signal sample; and
a second stage processing module configured to correlate a second set of RF signal samples corresponding to the interpolated tone to a plurality of code signals, and to output an output tone having a second correlation magnitude exceeding a second threshold value.

9. The signal acquisition device of claim 8, wherein the first stage processing module is configured identify the candidate RF signal sample among the correlated first set of RF signal samples based on the peak magnitude of the correlated first set of RF signal samples occurring during the programmable waiting period.

10. The signal acquisition device of claim 8, wherein the noise energy estimate is frozen beginning at a start of the programmable waiting period and ending at an end of a frequency pruning window.

11. The signal acquisition device of claim 8, wherein the first stage processing module is configured to ignore any of the first set of RF signal samples having a magnitude below the peak magnitude of the correlated first set of RF signal samples occurring during a frequency pruning window beginning at an end of the programmable waiting period.

12. The signal acquisition device of claim 11, wherein the frequency pruning window is a length of a signal burst within the first set of RF signal samples.

13. The signal acquisition device of claim 8, wherein the second stage processing module is configured to correlate the second set of RF signal samples using a window length based on the peak magnitude of the correlated first set of RF signal samples.

14. The signal acquisition device of claim 8, further comprising an application-specific integrated circuit (ASIC) or a field-programmable gate array (FPGA), wherein a number of the generated tones is based on a clock rate of the ASIC or FPGA and a rate of the first set of RF signal samples received by the ASIC or FPGA.

15. A signal acquisition device comprising:
a first stage processing module configured to
correlate a first set of radio frequency (RF) signal samples to a plurality of generated tones, and
output at least one interpolated tone based on the correlated first set of RF signal samples; and
a second stage processing module configured to correlate a second set of RF signal samples corresponding to the at least one interpolated tone to a plurality of code signals using a window length based on a peak magnitude of the correlated first set of RF signal samples, and to output an output tone having a second correlation magnitude exceeding a second threshold value.

16. The signal acquisition device of claim 15, wherein the first stage processing module is configured to identify a candidate RF signal sample among the correlated first set of RF signal samples based on the peak magnitude of the correlated first set of RF signal samples, the candidate RF signal sample having a first correlation magnitude exceeding a first threshold value, and wherein the interpolated tone is based on the candidate RF signal sample.

17. The signal acquisition device of claim 16, wherein the first stage processing module is configured identify the candidate RF signal sample among the correlated first set of RF signal samples based on the peak magnitude of the correlated first set of RF signal samples occurring during a programmable waiting period, wherein the programmable waiting period begins at a time when the candidate RF signal sample reaches the peak magnitude.

18. The signal acquisition device of claim 17, wherein the first stage processing module is further configured to generate a noise energy estimate based on an average correlation magnitude of each of the first set of RF signal samples occurring prior to and during the programmable waiting period, and wherein the first threshold value is based at least in part on the noise energy estimate.

19. The signal acquisition device of claim 17, wherein the first stage processing module is configured to ignore any of the first set of RF signal samples having a magnitude below the peak magnitude of the correlated first set of RF signal samples occurring during a frequency pruning window beginning at an end of the programmable waiting period.

20. The signal acquisition device of claim 19, wherein the frequency pruning window is a length of a signal burst within the first set of RF signal samples.
